(19) United States
(12) Patent Application Publication
(10) Pub. No.: US 2021/0241006 A1
(43) Pub. Date: Aug. 5, 2021

(54) HAZARD DETECTION AND WARNING SYSTEM AND METHOD

(71) Applicant: GM GLOBAL TECHNOLOGY OPERATIONS LLC, DETROIT, MI (US)

(72) Inventors: Md Ashabul Anam, Sterling Heights, MI (US); Venkatesh Gopalakrishnan, Troy (US); Taleah J. Slack, Royal Oak, MI (US)

(21) Appl. No.: 16/777,202

(22) Filed: Jan. 30, 2020

(51) Int. Cl. G06K 9/00; B60W 50/14; B60R 11/02

(52) U.S. Cl. CPC G06K 9/00805; B60W 50/14; B60R 11/0229; B60W 2756/10; B60R 2300/607; B60R 2300/8093; B60W 2420/54; B60W 2050/146

(57) ABSTRACT

A method to reduce a vehicle-hazard potential, the method including the steps of: detecting, via a sensor, one or more objects in a vehicle environment; determining whether these objects are of a specific type; and based on the specific type of the one or more objects, deterring the one or more objects from colliding with a vehicle.

### INTRODUCTION

Studies have estimated that each year includes approximately 1.5 million deer related vehicle accidents, resulting in over $1 billion in vehicle damage, approximately 200 vehicle occupant fatalities, as well as tens of thousands of injuries. Moreover, a majority of those deer-related car accidents occur at dusk or sometime in the late evening hours, when it very difficult to see animals out on the road. It is therefore desirable to provide a system and method that allows a vehicle to spot an animal or other potentially hazardous objects in advance and then use a deterrent mechanism to minimize the risk of an accident. It is further desirable to store the detection information in the cloud and then transfer this information as a warning to third-party vehicles in proximity of the potentially hazardous animal or object. Moreover, other desirable features and characteristics of the present invention will become apparent from the subsequent detailed description of the invention and the appended claims, taken in conjunction with the accompanying drawings and this background of the invention.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method to reduce a vehicle-hazard potential, the method including: detecting, via a sensor, one or more objects in a vehicle environment; determining whether the one or more objects are of a specific type; and based on the specific type of the one or more objects, deterring the one or more objects from colliding with a vehicle. Other embodiments of this aspect include corresponding computer systems, apparatus, and computer programs recorded on one or more computer storage devices, each configured to perform the actions of the methods.

Implementations may include one or more of the following features. The method further including the step of providing a potential-of-hazard notification to one or more vehicle occupants. The method where the potential-of-hazard notification is displayed as an image, where the image is a model of the vehicle environment constructed from sensor data. The method further including the step of transmitting sensor information of the one or more objects in the vehicle environment to a data center, where the data center is configured to convert the sensor information into warning information, where the data center is further configured to transmit the warning information to one or more third-party vehicles. The method where the determination of the one or more objects includes: creating a perceptual map of the vehicle environment from sensor information; locating one or more objects in the perceptual map; comparing the one or more objects to one or more test patterns; and where, when the one or more objects match the one or more test patterns, determining the one or more objects are of the specific type; otherwise, the objects are not of the specific type. The method where: the one or more objects are detected by passively receiving one or more sounds made by the one or more objects; the determination of the one or more objects includes: comparing the one or more sounds made by the one or more objects to one or more test patterns; and where, when the one or more sounds made by the one or more objects match the one or more test patterns, determining the objects are of a certain type; otherwise, the objects are not of the certain type. The method where the one or more objects are deterred via a deterrent device. Implementations of the described techniques may include hardware, a method or process, or computer software on a computer-accessible medium.

One general aspect includes a system to reduce a vehicle-hazard potential, the system includes: a memory configured to include a plurality of executable instructions and a processor configured to execute the executable instructions, where the executable instructions enable the processor to carry out the following steps: detecting, via a sensor, one or more objects in a vehicle environment; determining whether the one or more objects are of a specific type; and based on the specific type of the one or more objects, deterring the one or more objects from colliding with a vehicle. Other embodiments of this aspect include corresponding computer systems, apparatus, and computer programs recorded on one or more computer storage devices, each configured to perform the actions of the methods.

Implementations may include one or more of the following features. The system where the executable instructions enable the processor to carry out the additional step of providing a potential-of-hazard notification to one or more vehicle occupants. The system where the potential-of-hazard notification is displayed as an image, where the image is a model of the vehicle environment constructed from sensor data. The system where the executable instructions enable the processor to carry out the additional step of transmitting sensor information of the one or more objects in the vehicle environment to a data center, where the data center is configured to convert the sensor information into warning information, where the data center is further configured to transmit the warning information to one or more third-party vehicles. The system where the determination of the one or more objects includes: creating a perceptual map of the vehicle environment from sensor information; locating one or more objects in the perceptual map; comparing the one or more objects to one or more test patterns; and where, when the one or more objects match the one or more test patterns, determining the one or more objects are of the specific type; otherwise, the objects are not of the specific type. The system where: the one or more objects are detected by passively receiving one or more sounds made by the one or more objects; the determination of the one or more objects includes: comparing the one or more sounds made by the one or more objects to one or more test patterns; and where, when the one or more sounds made by the one or more objects match the one or more test patterns, determining the objects are of a certain type; otherwise, the objects are not of the certain type. The system where the one or more objects are deterred via a deterrent device. Implementations of the described techniques may include hardware, a method or process, or computer software on a computer-accessible medium.

One general aspect includes a non-transitory and machine-readable medium having stored thereon executable instructions adapted to reduce a vehicle-hazard potential, which when provided to a processor and executed thereby, causes the processor to carry out the following steps: detecting, via a sensor, one or more objects in a vehicle environment; determining whether the one or more objects are of a specific type; and based on the specific type of the one or more objects, deterring the one or more objects from colliding with a vehicle. Other embodiments of this aspect include corresponding computer systems, apparatus, and computer programs recorded on one or more computer storage devices, each configured to perform the actions of the methods.

Implementations may include one or more of the following features. The non-transitory and machine-readable medium where the processor to carries out the additional step of providing a potential-of-hazard notification to one or more vehicle occupants. The non-transitory and machine-readable medium where the potential-of-hazard notification is displayed as an image, where the image is a model of the vehicle environment constructed from sensor data. The non-transitory and machine-readable medium where the processor to carries out the additional step of transmitting sensor information of the one or more objects in the vehicle environment to a data center, where the data center is configured to convert the sensor information into warning information, where the data center is further configured to transmit the warning information to one or more third-party vehicles. The non-transitory and machine-readable medium where the determination of the one or more objects includes: creating a perceptual map of the vehicle environment from sensor information; locating one or more objects in the perceptual map; comparing the one or more objects to one or more test patterns; and where, when the one or more objects match the one or more test patterns, determining the one or more objects are of the specific type; otherwise, the objects are not of the specific type. The non-transitory and machine-readable medium where: the one or more objects are detected by passively receiving one or more sounds made by the one or more objects; the determination of the one or more objects includes: comparing the one or more sounds made by the one or more objects to one or more test patterns; and where, when the one or more sounds made by the one or more objects match the one or more test patterns, determining the objects are of a certain type; otherwise, the objects are not of the certain type. Implementations of the described techniques may include hardware, a method or process, or computer software on a computer-accessible medium.

The above features and advantages and other features and advantages of the present teachings are readily apparent from the following detailed description for carrying out the teachings when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of a communications system that is capable of utilizing the system and method disclosed herein;

FIG. 2 is an exemplary flow chart for the utilization of an exemplary system and method to reduce vehicle-hazard potential;

FIG. 3 is an exemplary flow chart for the utilization of an active detection technique that can be applied to an aspect of the process flow of FIG. 2;

FIG. 4 is an illustrative aspect of the process flow of FIG. 3;

FIG. 5 is an exemplary flow chart for the utilization of an active detection technique that can be applied to an aspect of the process flow of FIG. 2; and

FIG. 6 is an illustrative aspect of the process flow of FIG. 5.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present system and/or method. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

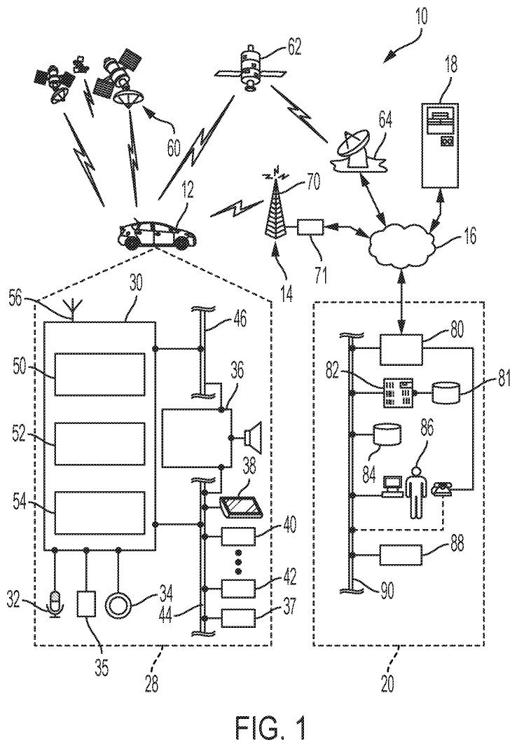

With reference to FIG. 1, there is shown an operating environment that includes, among other features, a mobile vehicle communications system 10 and that can be used to implement the method disclosed herein. Communications system 10 generally includes a vehicle 12, one or more wireless carrier systems 14, a land communications network 16, a computer 18, and a data center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including, but not limited to, motorcycles, trucks, busses, sports utility vehicles (SUVs), recreational vehicles (RVs), construction vehicles (e.g., bulldozers), trains, trolleys, marine vessels (e.g., boats), aircraft, helicopters, amusement park vehicles, farm equipment, golf carts, trams, etc., can also be used. Some of the vehicle electronics 28 is shown generally in FIG. 1 and includes a telematics unit 30, a microphone 32, one or more pushbuttons or other control inputs 34, a detection sensor 35, an audio system 36, a deterrent device 37, a visual display 38, and a GPS module 40 as well as a number of vehicle system modules (VSMs) 42. Some of these devices can be connected directly to the telematics unit 30 such as, for example, the microphone 32 and pushbutton(s) 34, detection sensor 35 whereas others are indirectly connected using one or more network connections, such as a communications bus 44 or an entertainment bus 46. Examples of suitable network connections include a controller area network (CAN), WIFI, Bluetooth and Bluetooth Low Energy, a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket transceiver device that is installed in the vehicle and that enables wireless voice and/or data communication over wireless carrier system 14 and via wireless networking. This enables the vehicle to communicate with data center 20, other telematics-enabled vehicles, or some other entity or device. The telematics unit 30 preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor 86 or voice response unit at the data center 20) and data communication (e.g., to provide GPS location data or vehicle diagnostic data to the data center 20), the system can utilize a single call over a voice channel and switch as needed between voice and data transmission over the voice channel, and this can be done using techniques known to those skilled in the art.

According to one embodiment, telematics unit 30 utilizes cellular communication according to standards such as LTE or 5G and thus includes a standard cellular chipset 50 for voice communications like hands-free calling, a wireless modem for data transmission (i.e., transceiver), an electronic processing device 52, at least one digital memory device 54, and an antenna system 56. It should be appreciated that the modem can either be implemented through software that is stored in the telematics unit and is executed by processor 52, or it can be a separate hardware component located internal or external to telematics unit 30. The modem can operate using any number of different standards or protocols such as, but not limited to, WCDMA, LTE, and 5G. Wireless networking between vehicle 12 and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Telematics Controller 52 (processor) can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Telematics Controller 52 executes various types of digitally-stored instructions, such as software or firmware programs stored in memory 54, which enable the telematics unit to provide a wide variety of services. For instance, controller 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services provided in connection with one or more vehicle system modules 42 (VSM); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit 30 is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to data center 20 or other remote computer system, such as computer 18, for other purposes, such as fleet management. Also, new or updated map data can be downloaded to the GPS module 40 from the data center 20 via the telematics unit 30.

Apart from the audio system 36 and GPS module 40, the vehicle 12 can include other VSMs 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests.

As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks, headlights, and horn system. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, detection sensor 35, audio system 36, deterrent device 37, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art.

The pushbutton(s) 34 allow manual user input into the telematics unit 30 to initiate wireless telephone calls and provide other data, response, or control input. Separate pushbuttons can be used for initiating emergency calls versus regular service assistance calls to the data center 20. Detection sensor 35 may be installed on the front bumper fascia and/or side panels of vehicle 12. Detection sensor 35 uses either infrasonic sound or ultrasonic sound propagation to detect objects in the environment surrounding the vehicle 12. In addition, detection sensor 35 may include passive detection capabilities (i.e., the sensor listens for sound made by third-party objects) as well as active detection capabilities (i.e., the sensor emits pulses of sound and then listens for echoes bouncing off third-party objects) or the sensor 35 may use both of these passive and active detection techniques. Detection sensor 35 may also be used for acoustic location purposes as well as the measurement of the echo characteristics of third-party objects to facilitate the generation of one or more perceptual maps. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM, media streaming services (e.g., PANDORA RADIO™, SPOTIFY™, etc.), satellite radio, CD, DVD, and other multimedia functionality. This functionality can be provided in conjunction with or independent of the infotainment module described above.

Deterrent device 37 can be mounted on the exterior body of vehicle 12 (e.g., the front right and left side corners of the vehicle's roof). Air moving through the device produces sound (e.g., ultrasound) that is intended to be heard by and warn animals (e.g., deer and dogs) in the environment of a vehicle's approach. Visual display 38 is preferably a graphics display, such as a touch screen on the instrument panel or a heads-up display reflected off of the windshield, and can be used to provide a multitude of input and output functions (i.e., capable of GUI implementation). Audio system 36 may also generate at least one audio notification to announce such third-party contact information is being exhibited on display 38 and/or may generate an audio notification which independently announces the third-party contact information. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more cellular network infrastructures (CNI) 71, as well as any other networking components required to connect wireless carrier system 14 with land network 16. Each cell tower 70 includes sending and receiving antennas and a base station, with the base stations from different cell towers being connected to the CNI 71 either directly or via intermediary equipment such as a base station controller. Cellular system 14 can implement any suitable communications technology, including for example, analog technologies such as AMPS, or the newer digital technologies such as, but not limited to, 4G LTE and 5G. As will be appreciated by skilled artisans, various cell tower/base station/CNI arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to data center 20. For example, land network 16 may include a public switched telephone network (PSTN) such as that used to provide hardwired telephony, packet-switched data communications, and the Internet infrastructure (i.e., a network of interconnected computing device nodes). One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, data center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer (e.g., a SIP Presence server) where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or data center 20, or both. A computer 18 can also be used for providing Internet connectivity such as DNS services or as a network address server that uses DHCP or other suitable protocol to assign an IP address to the vehicle 12.

Data center 20 is designed to provide the vehicle electronics 28 with a number of different system backend functions and, according to the exemplary embodiment shown here, generally includes one or more switches 80, servers 82, databases 84, live advisors 86, as well as an automated voice response system (VRS) 88, all of which are known in the art. These various data center components are preferably coupled to one another via a wired or wireless local area network 90. Switch 80, which can be a private branch exchange (PBX) switch, routes incoming signals so that voice transmissions are usually sent to either the live advisor 86 by regular phone, backend computer 87, or to the automated voice response system 88 using VoIP. Server 82 can incorporate a data controller 81 which essentially controls the operations of server 82. Server 82 may control data information as well as act as a transceiver to send and/or receive the data information (i.e., data transmissions) from one or more of the databases 84, telematics unit 30, and mobile computing device 57.

Controller 81 is capable of reading executable instructions stored in a non-transitory machine readable medium and may include one or more from among a processor, a microprocessor, a central processing unit (CPU), a graphics processor, Application Specific Integrated Circuits (ASICs), Field-Programmable Gate Arrays (FPGAs), state machines, and a combination of hardware, software and firmware components. The live advisor phone can also use VoIP as indicated by the broken line in FIG. 1. VoIP and other data communication through the switch 80 is implemented via a modem (i.e., a transceiver), connected between the land communications network 16 and local area network 90.

Data transmissions are passed via the modem to server 82 and/or database 84. Database 84 can store account information such as vehicle dynamics information and other pertinent subscriber information. Data transmissions may also be conducted by wireless systems, such as 802.11x, GPRS, and the like. Although the illustrated embodiment has been described as it would be used in conjunction with a manned data center 20 using live advisor 86, it will be appreciated that the data center can instead utilize VRS 88 as an automated advisor or, a combination of VRS 88 and the live advisor 86 can be used.

### Method

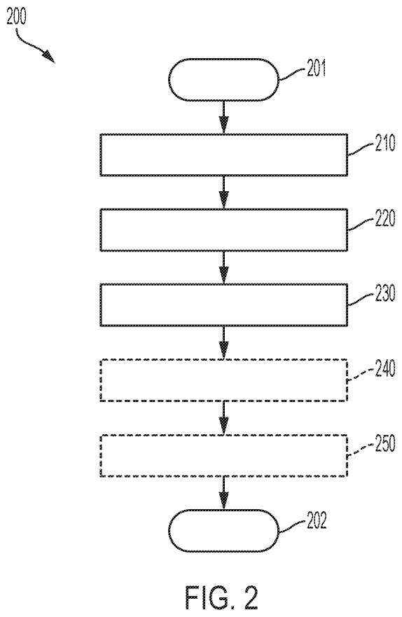

Turning now to FIG. 2, there is shown an embodiment of a method 200 to reduce the potential of a collision between a moving vehicle and a hazardous object, for example, an animal such as a deer, dog, or child. One or more aspects of the alert method 200 may be carried out by telematics unit 30. For example, in order to carry out the one or more aspects of method 200, memory 54 includes executable instructions stored thereon and processor 52 executes these executable instructions. One or more ancillary aspects of alert method 300 may also be completed by one or more vehicle devices such as, for example, detection sensor 35 and deterrent device 37.

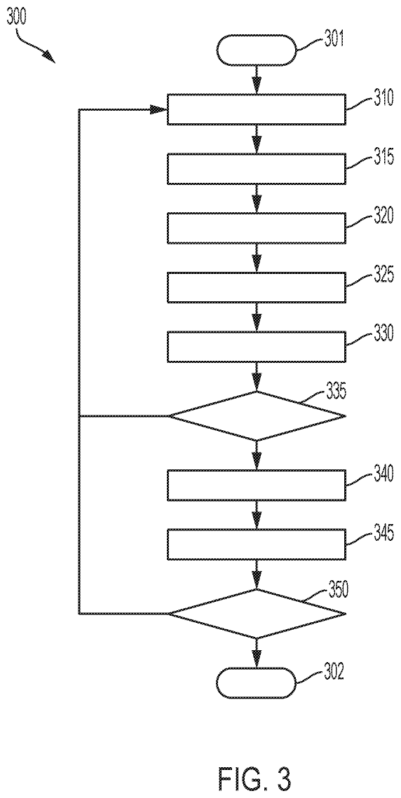

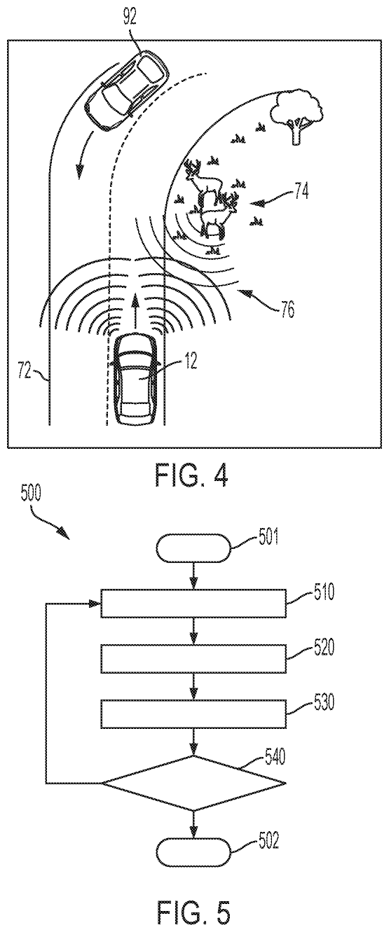

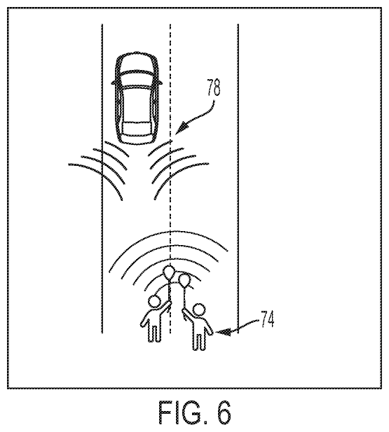

With additional reference to FIG. 2, method 200 begins at 201 in which vehicle 12 is travelling along a roadway 72 (FIG. 4). In step 210, vehicle 12 comes into proximity with a potentially hazardous object 74 on, near, or over roadway 72 such as, for example, an animal, rock debris, a low bridge, or barricade (shown in FIG. 4 as a couple of deer and in FIG. 6 as children). In addition, in this step, detection sensor 35 will detect the potentially hazardous object 74. In one or more embodiments, detection sensor 35 will use an active detection technique 76 (e.g., echolocation) when detecting object 74, as discussed below with regard to FIG. 3. In one or more alternative embodiments, detection sensor 35 will use a passive detection technique 78 (FIG. 6) when detecting object 74, as discussed below with regard to FIG. 6. Skilled artists will see that implementation of a passive detection technique can be helpful when the object 74 is around a blind corner and thus hidden from view of one or more vehicle occupants (e.g., the vehicle's driver). Skilled artists will also see passive detection can be used as a backup when detection sensor 35 lacks active detection capabilities.

In step 220, it will be determined whether the detected object 74 is of a specific type. This determination will be different based on whether detection sensor 35 implements an active detection technique 76 or a passive detection technique 78 (or both). As follows, non-exclusive embodiments of this determination process will be discussed below with regard to the active detection technique (FIG. 4) and the passive detection technique (FIG. 6).

In step 230, when it is determined that the detected object 74 is of a specific type, for example, an animal, telematics unit 30 will act to deter the object 74 from being at a position which is prone to colliding with the moving vehicle 12. In one or more embodiments, the deterrent device 37 will be activated to produce an audible alert through ultra sound noises to deter the animal from colliding with vehicle 12, for example, by startling it, provoking fear in the animal, and causing it to move in a direction away from roadway 72 out of said fear. In one or more alternative embodiments, the vehicle's horn system (not shown) will be activated to produce an audible alert through sequential horn honks that will deter the animal from colliding with vehicle 12, for example, by startling it, provoking fear in the animal, and causing it to move in a direction away from roadway 72 out of said fear. Skilled artists will see that activation of the vehicle's horn system is useful when such animals are human children who can not hear ultra sound noises from devices such as the deterrent device 37. In one or more alternative embodiments, the vehicle's headlamps (not shown) will be activated to produce a visual alert, which consists of multiple consecutive short light blinks (high or low beam) by either/both headlamps, that will deter the animal from colliding with vehicle 12, for example, by startling it, provoking fear in the animal, and causing it to move in a direction away from roadway 72 out of said fear.

In optional step 240, a potential-of-hazard notification will be produced in the cabin of vehicle 12 to notify one or more vehicle occupants (e.g., the vehicle's driver) that there is a potentially hazardous object 74 in the environment surrounding vehicle 12. In one or more embodiments, this notification is produced as a chime sound via audio system 36. In one or more embodiments, for example, when detection sensor 35 uses an active detection technique 76, the notification may exhibit the sensor information that has been constructed on display 38 as a virtual model of the nearfield surrounding environment of vehicle 12. As such, sunlight does not need to be present in the vehicle environment for the construction of this model and can be useful to display objects 74 not easily visible in the darkness of night, such as, for example, rock debris, low-hanging bridges, or barricades. It should be understood that, in certain embodiments, the potential-of-hazard notification will be used in itself to deter the driver from colliding with the potentially hazardous object.

In optional step 250, the collected sensor information (i.e., object detection info) will at least transitorily be stored to memory 54 and then transmitted to data center 20. Moreover, upon being received, data center 20 will convert the sensor information into warning information. Data center 20 will also locate one or more third-party vehicles 92 that are traveling in proximity (e.g., within 500 yards) and in a direction that is substantially towards object 74. Upon locating such vehicles 92, data center 20 will transmit to them the manufactured warning information, which can then be produced as a potential-of-hazard notification in the cabin of the one or more third-party vehicles 92. After step 250, method 200 will move to completion 202.

Turning now to FIG. 3, there can be seen an embodiment of active detection technique 300 to detect potentially hazardous objects 74 by emitting pulses (chirps) of sound and then listening for echoes bouncing off these objects 74 (i.e., echolocation). Method 300 (represented as reference number 76 in FIG. 4) will begin at 301 in which detection sensor 35 (e.g., a SENIX ultrasonic sensor) is in an operative state. In step 310, detection sensor will emit pulses of low frequency ultrasonic sound in a direction that projects away from vehicle 12 (e.g., forward or backwards), for example, via the activation of an acoustic pulse generator for creating acoustic pulses and a transducer for converting the pulses into sound and subsequent transmission thereof. In step 315, the low frequency ultrasonic sound pulses will bounce off one or more unknown objects 74 as echoes and will subsequently be captured by detection sensor 35 via an acoustic pickup component. In step 320, the weak/soft echoes (i.e., those having bounced off objects other than the unknown object of relevance) as well as ambient noise will be filtered such that only relevant echoes (i.e., those having bounced off the unknown object) will be processed. Moreover, one or more amplifiers may be used to enhance the amplitude of the relevant/strong echoes being processed.

In step 325, a perceptual map will be generated from the processed relevant/strong echoes. As such, this map should be a relatively accurate construction of the environment surrounded by vehicle 12. For example, the map can be constructed by viewing and recording the pertinent time delays of each relevant echo in light of the direction of the echo's travel. This map will also accurately construct a model of the vehicle environment regardless of whether daylight is present in the vehicle environment itself. In step 330, the pattern for the echoes from the unknown object 74 found in the perceptual map (i.e., the outline of the shape of the object 74) will be reviewed against one or more echo patterns (object shapes) stored in a database (test patterns). Moreover, a timer sequence may be implemented so that these echoes can be reviewed over a duration of time, or at two distinct times (via two perception maps), to perceive whether the unknown object 74 appears to be moving and, if so, in which direction these the object 74 is moving. In 335, it will be determined whether the echo pattern matches one or more test patterns. If the echo pattern does match one or more test patterns, in essence, the detected object found in the map has tested positive as being a potentially hazardous object 74 (i.e., an object of a specific type), method 300 will move to step 340. Otherwise, when the detected object tests negative, method 300 will return to step 310.

In step 340, detection sensor 35 will emit pulses of high frequency sound that are focused in the direction of the detected object which tested positive. Moreover, the high frequency ultrasonic sound pulses will bounce off the detected object 74 as echoes and will subsequently be captured by detection sensor 35 to provide a more accurate detection than the detection produced by low frequency sound (i.e., object echoes can be different with varying frequency patterns). In step 345, these high frequency echoes will be filtered to produce the shape of the detected object and subsequently reviewed against the test pattern(s) previously retrieved from the corresponding database. In step 350, it will be determined whether the high frequency echo pattern matches previously retrieved test pattern(s). If the high frequency echo pattern matches the test pattern(s), method 300 will move to completion 302 because the detected object is verified as being potentially hazardous. Otherwise, when the original outcome for the detected object is found to actually be false (i.e., the test result of step 335 is a false positive), method 300 will return to step 310.

Upon completion 302, which only occurs when a detected object 74 is determined to be of a potentially hazardous type, telematics unit 30 will act to deter the detected object 74 from being at a position which is prone to colliding with the moving vehicle 12. As examples of this deterrence, as discussed in more detail above, deterrent device 37 can be activated to produce an audible alert, the vehicle's horn system (not shown) can be activated to produce sequential horn honks, and/or one or more headlamps (not shown) can be activated to produce multiple consecutive short light blinks (high or low beam). Moreover, a potential-of-hazard notification can be produced in the cabin of vehicle 12 to notify one or more vehicle occupants (e.g., the vehicle's driver) that there is a potentially hazardous object 74 in the environment surrounding vehicle 12. As discussed above, this notification can be a chime sound and/or a model of the nearfield surrounding environment of vehicle 12. In addition, upon completion 302, the sensor information (e.g., the high/low frequency echo patterns of the detected object) can be transmitted to data center 20, so that the data center 20 can transmit one or more warnings to third-party vehicles 92 in proximity to the detected object that is indicated as of a potentially hazardous type.

Turning now to FIG. 5, there can be seen an embodiment of passive detection technique 500 to listen for one or more sounds made by potentially hazardous objects and which can be used as a backup technique when active sonar capabilities are not available (or detection sensor 35 is not equipped for active sonar detection). Method 500 (represented as reference number 78 in FIG. 6) will begin at 501 in which detection sensor 35 is in an operative state and listening for sounds in the environment surrounding vehicle 12. In step 510, detection sensor 35 will detect sounds from one or more unknown objects in the vehicle's environment. In step 520, the weak/soft sound patterns (i.e., those detected from objects other than the unknown object) as well as ambient noise will be filtered such that only relevant sound patterns (i.e., those detected from the unknown object) will be processed. In step 530, the filtered sound pattern from the unknown object 74 will be reviewed against one or more sound patterns (object shapes) stored in a database (test patterns). In step 540, it will be determined whether the sound pattern matches the one or more test patterns. If the sound pattern is determined to match the test pattern(s), in essence, the detected object found in the map has tested positive as being a potentially hazardous object 74 (i.e., an object of a specific type), method 500 will move to completion 502. Otherwise, when the detected object tests negative, method 500 will return to step 510.

Upon completion 502, which only occurs when a detected object is determined to be of a potentially hazardous type, telematics unit 30 will act to deter the potentially hazardous object 74 from being at a position which is prone to colliding with the moving vehicle 12. As examples of this deterrence, as discussed in more detail above, deterrent device 37 can be activated to produce an audible alert, the vehicle's horn system (not shown) can be activated to produce sequential horn honks, and/or one or more headlamps (not shown) can be activated to produce multiple consecutive short light blinks (high or low beam). Moreover, a potential-of-hazard notification can be produced in the cabin of vehicle 12 to notify one or more vehicle occupants (e.g., the vehicle's driver) that there is a potentially hazardous object 74 in the surrounding environment. As discussed above, this notification can be a chime sound and/or a model of the nearfield surrounding environment of vehicle 12. In addition, upon completion 502, the sensor information (e.g., the sound patterns of the detected object) can be transmitted to data center 20, so that the data center 20 can transmit one or more warnings to third-party vehicles 92 in proximity to the detected object that is indicated as of a potentially hazardous type.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the system and/or method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

What is claimed is:

1. A method to reduce a vehicle-hazard potential, the method comprising:
detecting, via a sensor, one or more objects in a vehicle environment;
determining whether the one or more objects are of a specific type; and
based on the specific type of the one or more objects, deterring the one or more objects from colliding with a vehicle.

2. The method of claim 1, further comprising the step of providing a potential-of-hazard notification to one or more vehicle occupants.

3. The method of claim 2, wherein the potential-of-hazard notification is displayed as an image, wherein the image is a model of the vehicle environment constructed from sensor data.

4. The method of claim 1, further comprising the step of transmitting sensor information of the one or more objects in the vehicle environment to a data center, wherein the data center is configured to convert the sensor information into warning information, wherein the data center is further configured to transmit the warning information to one or more third-party vehicles.

5. The method of claim 1, wherein the determination of the one or more objects comprises:
creating a perceptual map of the vehicle environment from sensor information;
locating one or more objects in the perceptual map;
comparing the one or more objects to one or more test patterns; and
wherein, when the one or more objects match the one or more test patterns, determining the one or more objects are of the specific type; otherwise, the objects are not of the specific type.

6. The method of claim 1, wherein:
the one or more objects are detected by passively receiving one or more sounds made by the one or more objects;
the determination of the one or more objects comprises:
comparing the one or more sounds made by the one or more objects to one or more test patterns; and
wherein, when the one or more sounds made by the one or more objects match the one or more test patterns, determining the objects are of a certain type; otherwise, the objects are not of the certain type.

7. The method of claim 1, wherein the one or more objects are deterred via a deterrent device.

8. A system to reduce a vehicle-hazard potential, the system comprises:
a memory configured to comprise a plurality of executable instructions and a processor configured to execute the executable instructions, wherein the executable instructions enable the processor to carry out the following steps:
detecting, via a sensor, one or more objects in a vehicle environment;
determining whether the one or more objects are of a specific type; and
based on the specific type of the one or more objects, deterring the one or more objects from colliding with a vehicle.

9. The system of claim 8, wherein the executable instructions enable the processor to carry out the additional step of providing a potential-of-hazard notification to one or more vehicle occupants.

10. The system of claim 9, wherein the potential-of-hazard notification is displayed as an image, wherein the image is a model of the vehicle environment constructed from sensor data.

11. The system of claim 8, wherein the executable instructions enable the processor to carry out the additional step of transmitting sensor information of the one or more objects in the vehicle environment to a data center, wherein the data center is configured to convert the sensor information into warning information, wherein the data center is further configured to transmit the warning information to one or more third-party vehicles.

12. The system of claim 8, wherein the determination of the one or more objects comprises:
creating a perceptual map of the vehicle environment from sensor information;
locating one or more objects in the perceptual map;
comparing the one or more objects to one or more test patterns; and
wherein, when the one or more objects match the one or more test patterns, determining the one or more objects are of the specific type; otherwise, the objects are not of the specific type.

13. The system of claim 8, wherein:
the one or more objects are detected by passively receiving one or more sounds made by the one or more objects;
the determination of the one or more objects comprises:
comparing the one or more sounds made by the one or more objects to one or more test patterns; and
wherein, when the one or more sounds made by the one or more objects match the one or more test patterns, determining the objects are of a certain type; otherwise, the objects are not of the certain type.

14. The system of claim 8, wherein the one or more objects are deterred via a deterrent device.

15. A non-transitory and machine-readable medium having stored thereon executable instructions adapted to reduce a vehicle-hazard potential, which when provided to a processor and executed thereby, causes the processor to carry out the following steps:
detecting, via a sensor, one or more objects in a vehicle environment;
determining whether the one or more objects are of a specific type; and
based on the specific type of the one or more objects, deterring the one or more objects from colliding with a vehicle.

16. The non-transitory and machine-readable medium of claim 15, wherein the processor to carries out the additional step of providing a potential-of-hazard notification to one or more vehicle occupants.

17. The non-transitory and machine-readable medium of claim 16, wherein the potential-of-hazard notification is displayed as an image, wherein the image is a model of the vehicle environment constructed from sensor data.

18. The non-transitory and machine-readable medium of claim 15, wherein the processor to carries out the additional step of transmitting sensor information of the one or more objects in the vehicle environment to a data center, wherein the data center is configured to convert the sensor information into warning information, wherein the data center is further configured to transmit the warning information to one or more third-party vehicles.

19. The non-transitory and machine-readable medium of claim 15, wherein the determination of the one or more objects comprises:
creating a perceptual map of the vehicle environment from sensor information;
locating one or more objects in the perceptual map;
comparing the one or more objects to one or more test patterns; and
wherein, when the one or more objects match the one or more test patterns, determining the one or more objects are of the specific type; otherwise, the objects are not of the specific type.

20. The non-transitory and machine-readable medium of claim 15, wherein:
the one or more objects are detected by passively receiving one or more sounds made by the one or more objects;
the determination of the one or more objects comprises:
comparing the one or more sounds made by the one or more objects to one or more test patterns; and
wherein, when the one or more sounds made by the one or more objects match the one or more test patterns, determining the objects are of a certain type; otherwise, the objects are not of the certain type.
